(19) United States
(12) Patent Application Publication
(10) Pub. No.: US 2025/0199507 A1
(43) Pub. Date: Jun. 19, 2025

(54) ADDITIVE MANUFACTURING PATH GENERATION DEVICE, ADDITIVE MANUFACTURING PATH GENERATION METHOD, ADDITIVE MANUFACTURING SYSTEM, AND ADDITIVE MANUFACTURING METHOD

(71) Applicant: Mitsubishi Electric Corporation, Tokyo (JP)

(72) Inventors: Kenji IRIGUCHI, Tokyo (JP); Nobuyuki SUMI, Tokyo (JP); Maiku HAYASHI, Tokyo (JP); Shinji FUJISHIRO, Nagoya-shi, Aichi (JP)

(73) Assignee: Mitsubishi Electric Corporation, Tokyo (JP)

(21) Appl. No.: 18/847,314

(22) PCT Filed: Mar. 24, 2022
(86) PCT No.: PCT/JP2022/014027

§ 371 Date: Sep. 16, 2024

(51) Int. Cl. G05B 19/4099; B29C 64/386; B33Y 50/00

(52) U.S. Cl. CPC G05B 19/4099; B29C 64/386; B33Y 50/00; G05B 2219/49023

(57) ABSTRACT

An additive manufacturing path generation device that generates a manufacturing path for manufacturing a manufactured object by layering layers each formed by adding a material along the manufacturing path includes: a reference path generation unit that generates, for each of the layers, a reference path from an intersection line between a layer definition surface and a reference path surface, the layer definition surface defining a target layer, the reference path surface restraining a position of the reference path for generating the manufacturing path; and a manufacturing path generation unit that generates, for each of the layers, manufacturing path candidates a plurality of paths parallel to the reference path in the layer definition surface, and generates the manufacturing path on the basis of the generated manufacturing path candidates, and the reference path generation unit generates the reference paths based on the single reference path surface common to the layers.

### FIELD

The present disclosure relates to an additive manufacturing path generation device for generating a manufacturing path for manufacturing a manufactured object by layering molten materials, an additive manufacturing path generation method, an additive manufacturing system, and an additive manufacturing method.

### BACKGROUND

In the field of additive manufacturing in which a three-dimensional manufactured object is manufactured by layering molten materials, it is preferable from the viewpoint of efficiency that continuous manufacturing can be performed for a long time with a manufacturing path for manufacturing each layer. In Patent Literature 1, in order that continuous manufacturing can be performed for a long time, a reference path is determined for each layer depending on a geometric contour of a cross section of each layer, and a manufacturing path is generated on the basis of the determined reference path.

### CITATION LIST

### Patent Literature

Patent Literature 1: Japanese Translation of PCT International Application Laid-open No. 2015-527225

### SUMMARY OF INVENTION

### Problem to be Solved by the Invention

However, according to the above-described conventional technique, the reference path is determined for each layer on the basis of the geometric contour of the cross section of each layer, so that there may arise positional deviation of a manufacturing path between upper and lower layers to be layered, and thus a manufacturing defect such as sagging may occur, which is a problem.

The present disclosure has been made in view of the above, and an object thereof is to obtain an additive manufacturing path generation device capable of easily obtaining a manufacturing path with which continuous manufacturing can be performed for a long time while reducing occurrence of a manufacturing defect.

### Means to Solve the Problem

To solve the above problem and achieve the object, the present disclosure provides an additive manufacturing path generation device to generate a manufacturing path for manufacturing a manufactured object by layering a plurality of layers each formed by adding a material along the manufacturing path, the additive manufacturing path generation device comprising: a reference path generation unit to generate, for each of the plurality of layers for manufacturing the manufactured object, a reference path from an intersection line between a layer definition surface and a reference path surface, the layer definition surface defining a target layer, the reference path surface being a surface that restrains a position of the reference path that is a reference for generating the manufacturing path; and a manufacturing path generation unit to generate, for each of the plurality of layers, a plurality of paths parallel to the reference path in the layer definition surface, the plurality of paths being manufacturing path candidates, and to generate the manufacturing path on a basis of the generated manufacturing path candidates, wherein the reference path generation unit generates a plurality of the reference paths corresponding in one-to-one to the plurality of layers on a basis of the reference path surface, the reference path surface being single in number and common to the plurality of layers.

### Effects of the Invention

The present disclosure achieves an effect that it is possible to easily obtain a manufacturing path with which continuous manufacturing can be performed for a long time while reducing occurrence of a manufacturing defect.

### BRIEF DESCRIPTION OF DRAWINGS

FIG. 1 is a diagram illustrating a functional configuration of an additive manufacturing path generation device according to a first embodiment.

FIG. 2 is a flowchart for describing an operation of the additive manufacturing path generation device illustrated in FIG. 1.

FIG. 3 is a flowchart for describing details of an operation of generating a manufacturing path by the additive manufacturing path generation device illustrated in FIG. 1.

FIG. 4 is a diagram illustrating an example of manufacturing shape data input to the additive manufacturing path generation device illustrated in FIG. 1.

FIG. 5 is a diagram illustrating an example of layer definition data input to the additive manufacturing path generation device illustrated in FIG. 1.

FIG. 6 is a diagram illustrating examples of layers defined by the layer definition data illustrated in FIG. 5 and a reference path surface in a manufacturing shape included in the manufacturing shape data illustrated in FIG. 4.

FIG. 7 is a diagram illustrating an example of a layer cross-sectional region generated by the additive manufacturing path generation device illustrated in FIG. 1.

FIG. 8 is a diagram illustrating a reference path generated in the example illustrated in FIG. 7.

FIG. 9 is a diagram illustrating an example of path definition data.

FIG. 10 is a diagram illustrating examples of a layer cross-sectional region and a reference path.

FIG. 11 is a diagram illustrating examples of manufacturing path candidates generated for the layer cross-sectional region illustrated in FIG. 10.

FIG. 12 is a diagram illustrating manufacturing paths generated from the manufacturing path candidates illustrated in FIG. 11.

FIG. 13 is an explanatory diagram regarding a procedure of generating a manufacturing path from a manufacturing path candidate.

FIG. 14 is an explanatory diagram regarding setting of an initial beam direction.

FIG. 15 is an explanatory diagram regarding a method for correcting a beam direction in an overhang portion.

FIG. 16 is an explanatory diagram regarding correction of a beam direction in a gradual change section.

FIG. 17 is a diagram illustrating examples of beam directions after correction.

FIG. 18 is a diagram illustrating examples of manufacturing paths as targets of a beam direction setting unit illustrated in FIG. 1.

FIG. 19 is a diagram illustrating an exemplary configuration of a computer system that realizes the additive manufacturing path generation device according to the first embodiment.

FIG. 20 is a diagram illustrating a configuration of an additive manufacturing system including the additive manufacturing path generation device illustrated in FIG. 1.

### DESCRIPTION OF EMBODIMENTS

Hereinafter, an additive manufacturing path generation device, an additive manufacturing path generation method, an additive manufacturing system, and an additive manufacturing method according to an embodiment of the present disclosure will be described in detail with reference to the drawings.

### First Embodiment

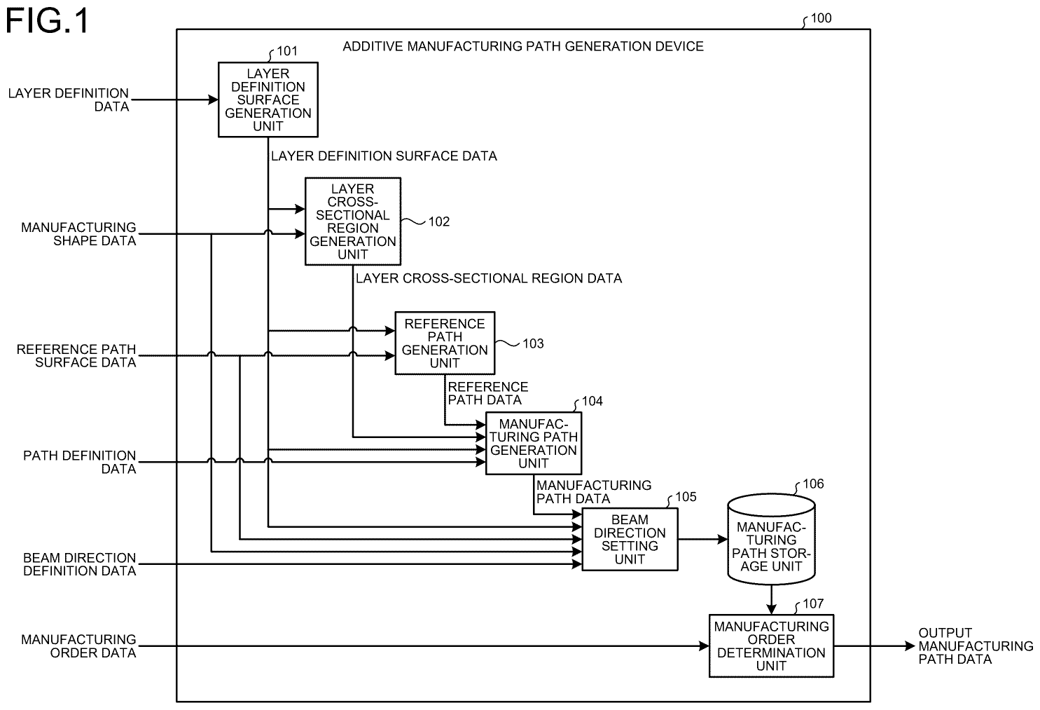

FIG. 1 is a diagram illustrating a functional configuration of an additive manufacturing path generation device 100 according to a first embodiment. The additive manufacturing path generation device 100 includes a layer definition surface generation unit 101, a layer cross-sectional region generation unit 102, a reference path generation unit 103, a manufacturing path generation unit 104, a beam direction setting unit 105, a manufacturing path storage unit 106, and a manufacturing order determination unit 107. The additive manufacturing path generation device 100 generates a manufacturing path for manufacturing a manufactured object by layering a plurality of layers each formed by adding a material along the manufacturing path. The additive manufacturing path generation device 100 divides a manufacturing shape of a manufactured object as a target into a plurality of layers each of which is a unit of manufacturing, and generates a manufacturing path for each of the divided layers. An additive manufacturing apparatus 200 to be described later (not illustrated in FIG. 1) forms each layer by adding a material along the manufacturing path, and layers a plurality of layers, and thereby a manufactured object having a desired manufacturing shape is manufactured.

On the basis of layer definition data that defines a layer which is a unit of manufacturing the manufactured object as a target, the layer definition surface generation unit 101 generates a layer definition surface which is a surface that defines each layer, and outputs layer definition surface data indicating the generated layer definition surface to each of the layer cross-sectional region generation unit 102, the reference path generation unit 103, the manufacturing path generation unit 104, and the beam direction setting unit 105. The layer definition data can include information indicating a position of each layer. Note that the layer definition surface generation unit 101 may generate the layer definition surface on per layer basis, or may collectively generate layer definition surfaces of a plurality of layers. Details of the layer definition surface will be described later.

On the basis of the layer definition surface data generated by the layer definition surface generation unit 101 and manufacturing shape data indicating the shape of a portion to be additively manufactured, the layer cross-sectional region generation unit 102 generates layer cross-sectional region data indicating a cross-sectional region defined by the layer definition surface in the manufactured object, and outputs the generated layer cross-sectional region data to the manufacturing path generation unit 104. The manufacturing shape data is input from the outside of the additive manufacturing path generation device 100, for example. The layer cross-sectional region generation unit 102 can generate layer cross-sectional region data indicating a plurality of cross-sectional regions each defined by the corresponding one of a plurality of layer definition surfaces.

The reference path generation unit 103 generates, for each of the plurality of layers for manufacturing the manufactured object, a reference path as a reference for generating a manufacturing path, on the basis of a layer definition surface that defines a target layer and a reference path surface. For example, the reference path generation unit 103 can define an intersection line between the layer definition surface and the reference path surface, as the reference path. The reference path surface is a surface that restrains a position of the reference path that is a reference for generating the manufacturing path. The reference path surface can be defined from a part of the surface of the manufactured object, a neutral surface of the manufactured object, and the like. The reference path generation unit 103 can generate the reference path by using the reference path surface input from the outside of the additive manufacturing path generation device 100. The reference path generation unit 103 can define a reference path of each layer as each of a plurality of intersection lines between the one reference path surface and the corresponding one of a plurality of layer definition surfaces. That is, the reference path generation unit 103 generates a plurality of reference paths corresponding in one-to-one to the plurality of layers, on the basis of the single reference path surface common to the plurality of layers. Since the plurality of reference paths each corresponding to one of the plurality of layers are included in the reference path surface, it can also be said that the reference path surface is a surface that restrains the positions of the reference paths. The reference path generation unit 103 outputs reference path data indicating the generated reference paths to the manufacturing path generation unit 104.

On the basis of the layer definition surface data output by the layer definition surface generation unit 101, the layer cross-sectional region data output by the layer cross-sectional region generation unit 102, the reference path data output by the reference path generation unit 103, and path definition data input from the outside of the additive manufacturing path generation device 100, the manufacturing path generation unit 104 generates a manufacturing path, and outputs manufacturing path data indicating the generated manufacturing path to the beam direction setting unit 105. The path definition data includes conditions of the manufacturing path to be generated, and specifically, can include an interval between manufacturing paths, and a manufacturing region distance which is a distance for representing a manufacturing region with respect to the manufacturing path. The manufacturing path generation unit 104 can generate, for each of the plurality of layers, a plurality of paths parallel to the reference path in the layer definition surface, the plurality of paths being manufacturing path candidates, and generate a manufacturing path on the basis of the generated manufacturing path candidates. Details of a method for generating a manufacturing path will be described later.

Here, the manufacturing path data generated by the additive manufacturing path generation device 100 includes data on a position and a beam direction with respect to each vertex of a polygonal line when an ideal manufacturing path is approximately expressed by the polygonal line. The beam direction is an irradiation direction of a beam for melting a material when each layer is formed.

On the basis of the layer definition surface data output by the layer definition surface generation unit 101, the manufacturing path data output by the manufacturing path generation unit 104, reference path surface data input from the outside of the additive manufacturing path generation device 100, the manufacturing shape data input from the outside of the additive manufacturing path generation device 100, and beam direction definition data input from the outside of the additive manufacturing path generation device 100, the beam direction setting unit 105 adds information indicating the beam direction to the manufacturing path data to thereby set the beam direction, and stores the manufacturing path data after the setting of the beam direction in the manufacturing path storage unit 106. After setting an initial beam direction for a manufacturing path, the beam direction setting unit 105 extracts an overhang portion in the manufacturing path in which the initial beam direction has been set, and corrects a beam direction to be set for each of the overhang portion and a portion adjacent to the overhang portion from the initial beam direction, thereby setting the beam direction. Here, the overhang portion refers to a portion having a shape in which an upper layer protrudes farther outward from a side surface than a lower layer. The beam direction definition data includes conditions for setting the beam direction, and includes, for example, information designating a method for calculating the initial beam direction, and data related to correction of the initial beam direction.

The manufacturing path storage unit 106 stores the manufacturing path data from the beam direction setting unit 105. The manufacturing path storage unit 106 can supply the manufacturing path data to the manufacturing order determination unit 107 in response to a request from the manufacturing order determination unit 107.

The manufacturing order determination unit 107 acquires the manufacturing path data in the order designated from the manufacturing path storage unit 106 on the basis of manufacturing order data input from the outside of the additive manufacturing path generation device 100, and outputs, as output manufacturing path data to the outside of the additive manufacturing path generation device 100, path data in which movement path data for movement between manufacturing paths is inserted between the manufacturing path data and the manufacturing path data thus acquired.

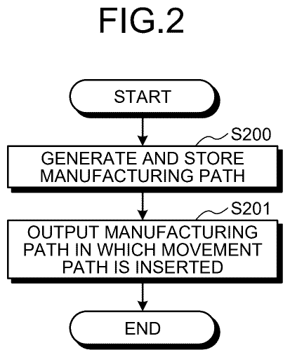

FIG. 2 is a flowchart for describing an operation of the additive manufacturing path generation device 100 illustrated in FIG. 1.

The additive manufacturing path generation device 100 generates manufacturing path data for the manufacturing of the entirety of the manufacturing shape by operations of the layer definition surface generation unit 101, the layer cross-sectional region generation unit 102, the reference path generation unit 103, the manufacturing path generation unit 104, and the beam direction setting unit 105, and stores the generated data in the manufacturing path storage unit 106 (step S200).

On the basis of the manufacturing path data stored in the manufacturing path storage unit 106 and data designating the manufacturing order included in the manufacturing order data input from the outside of the additive manufacturing path generation device 100, the manufacturing order determination unit 107 extracts the manufacturing path data in the designated order, and outputs, as output manufacturing path data to the outside of the additive manufacturing path generation device 100, a path in which a movement path for movement between manufacturing paths is inserted between the manufacturing paths (step S201).

The data designating the manufacturing order designates a combination of a pattern of outputting order of manufacturing paths and a pattern of directions of manufacturing paths. Regarding the pattern of outputting order of manufacturing paths, there are the following patterns (a) to (c), and regarding the pattern of directions of manufacturing paths, there are the following patterns (i) and (ii). A manufacturing shape number is a number for identifying each manufacturing shape, a layer number is a number for identifying a layer which is a unit of manufacturing, and an adjacent number is a number sequentially assigned to each manufacturing path in an adjacent direction from the manufacturing path on the reference path.
(a) Manufacturing paths are output in order of the adjacent numbers for each of the layer numbers for each of the manufacturing shape numbers
(b) Manufacturing paths are output in order of the adjacent numbers for each of the manufacturing shape numbers for each of the layer numbers
(c) Manufacturing paths are output in order of the manufacturing shape numbers for each of the same adjacent numbers for each of the layer numbers
   (i) Directions of adjacent manufacturing paths are made to be the same direction
   (ii) Directions of adjacent manufacturing paths are made to be reversed directions every other manufacturing path

The patterns of outputting order of manufacturing paths are in the order of (a), (b), and (c) when arranged in the descending order of concentration of portions to be manufactured. That is, the portions to be manufactured are more likely to be dispersed in (b) than in (a), and the portions to be manufactured are more likely to be dispersed in (c) than in (b). In a case where (a) or (b) is designated as the pattern of outputting order of manufacturing paths, the movement between manufacturing paths is smaller and the portions to be manufactured tend to be more concentrated in (ii) than in (i) of the patterns of directions of manufacturing paths. In a case where the data designating the manufacturing order designates a combination of (a) and (ii), the portions to be manufactured are more concentrated and thus the movement between manufacturing paths tends to be reduced. When the portions to be manufactured are concentrated and the movement between manufacturing paths is reduced, there is an advantage that a manufacturing time can be shortened, but heat storage is likely to proceed, and thus the possibility of causing a problem such as collapse of the manufacturing shape tends to increase. On the other hand, in the pattern of (c), the portions to be manufactured are likely to be dispersed, and the movement between manufacturing paths increases. Since the movement between manufacturing paths increases, the manufacturing time tends to be long, but the heat storage is prevented, and thus the possibility of causing a problem such as collapse of the manufacturing shape tends to be reduced.

As described above, regarding the patterns that designates the manufacturing order, a suitable pattern is different depending on a manufacturing shape, or on a substrate used for manufacturing or a material for a manufactured object, and therefore, when the manufacturing order can be designated from the outside of the additive manufacturing path generation device 100, then an appropriate method can be selected depending on manufacturing characteristics.

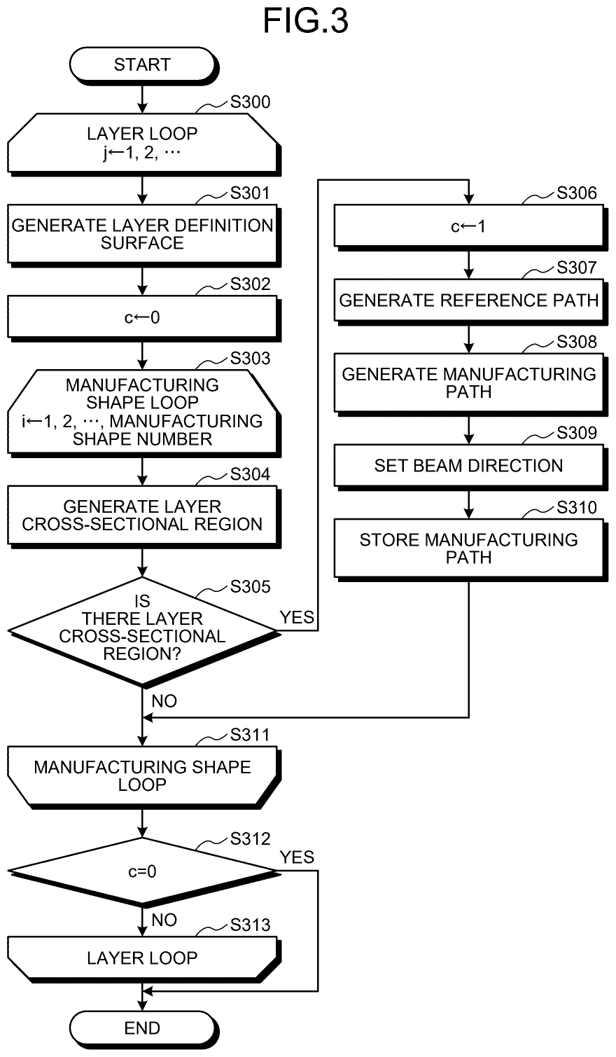

FIG. 3 is a flowchart for describing details of an operation of generating a manufacturing path by the additive manufacturing path generation device 100 illustrated in FIG. 1. The operation illustrated in FIG. 3 corresponds to details of step S200 in FIG. 2.

First, an example of data used to generate the manufacturing path will be described.

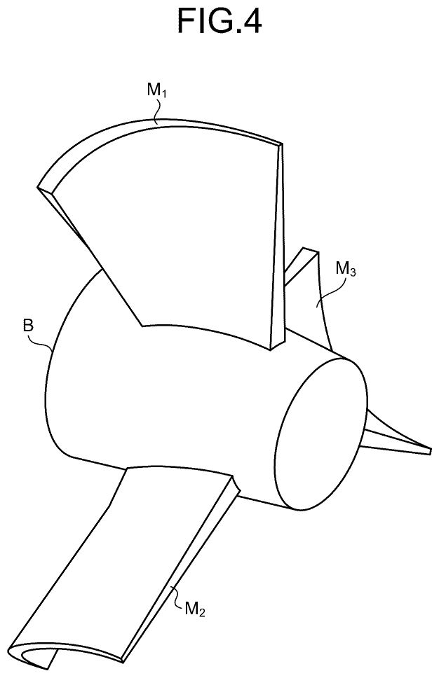

FIG. 4 is a diagram illustrating an example of manufacturing shape data input to the additive manufacturing path generation device 100 illustrated in FIG. 1. A manufactured object illustrated in FIG. 4 has three portions to be manufactured for one substrate B, and manufacturing shape numbers starting from 1 are each assigned to one of the portions. Specifically, the manufacturing shape data includes shape data of three manufacturing shapes M₁ to M₃ to be manufactured for one substrate B.

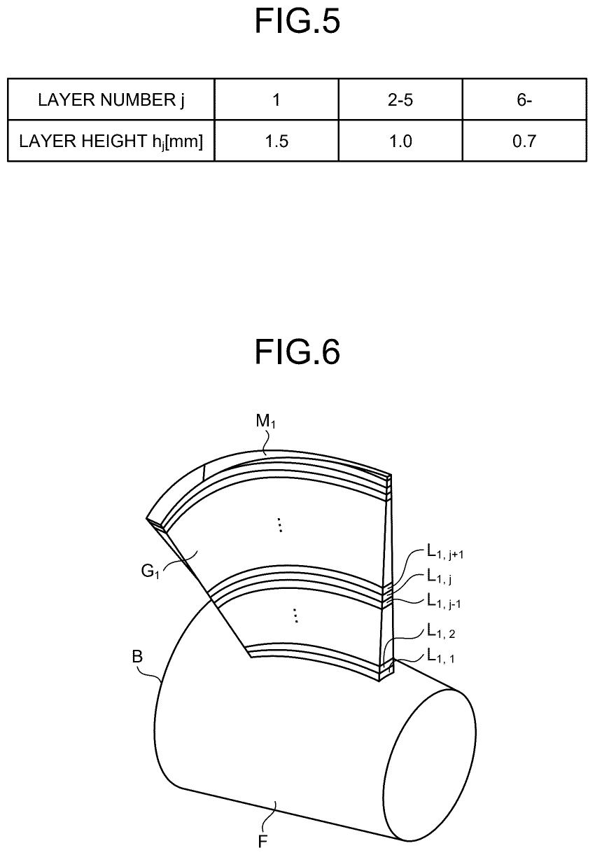

FIG. 5 is a diagram illustrating an example of layer definition data input to the additive manufacturing path generation device 100 illustrated in FIG. 1. The layer definition data includes a layer number j for identifying each layer and a layer height hⱼ which is the height of each layer from a surface as reference.

FIG. 6 is a diagram illustrating examples of layers defined by the layer definition data illustrated in FIG. 5 and a reference path surface in the manufacturing shape M₁ included in the manufacturing shape data illustrated in FIG. 4. With a surface F on the substrate B as a reference surface, the layer height hⱼ illustrated in FIG. 5 is height from the surface F. Layers are each assigned one of layer numbers starting from 1 in the descending order of closeness to the surface F. A portion of the manufacturing shape M₁ of which the layer number is j is referred to as a layer L_{i,j}. The layer L_{i,j} is defined as a portion sandwiched between a surface obtained by offsetting the surface F by a distance dⱼ in a perpendicular direction and a surface obtained by offsetting the surface F by a distance dⱼ₊₁ in the perpendicular direction. Here, di is expressed by the following formula (1). Provided that hₒ=0 holds.

$$Formula 1$$

$${d}_{j} = {\sum }_{k = 0}^{k = j - 1} {h}_{k} \qquad ( 1 )$$

Pieces of data on reference path surfaces assigned the same manufacturing shape number are given to the manufacturing shapes M₁ to M₃. In the example illustrated in FIG. 6, data on a reference path surface G₁ is given to the manufacturing shape M₁. Here, the reference path surface G₁ is a surface defined from a part of the surface of the manufacturing shape M₁. In the example illustrated in FIG. 6, the reference path surface G₁ is one of a plurality of surfaces constituting the manufacturing shape M₁. The reference path surface may be a surface defined by various methods, for example, a surface defined on the basis of a neutral surface of the manufacturing shape, and it is possible to select an appropriate surface depending on the manufacturing shape.

Returning to the description of FIG. 3. First, the layer definition surface generation unit 101 sets, by a layer loop process repeatedly performed for each layer, the layer number j for generating layer definition surface data of each layer so as to increase by one for each repetition starting from 1 (step S300).

The layer definition surface generation unit 101 generates a layer definition surface Fⱼ corresponding to the layer number j (step S301). The layer definition surface generation unit 101 generates the layer definition surface Fⱼ by offsetting the surface F on the substrate B included in the layer definition data by the distance di expressed by the formula (1) in the perpendicular direction. Here, the layer definition surface Fⱼ is a surface including a cross-sectional region closest to the substrate B in each layer, but the layer definition surface Fⱼ is not limited to the above example, and may be a surface representing each layer and including a cross-sectional region farthest from the substrate B in each layer. In that case, the layer definition surface generation unit 101 is only required to generate the layer definition surface F; with the distance dⱼ₊₁ as a distance by which the surface F is offset. Alternatively, the layer definition surface Fⱼ can be a surface including a cross-sectional region in the middle of the thickness of the layer in the perpendicular direction of the surface F. In that case, the layer definition surface generation unit 101 is only required to set the distance by which the surface F is offset to (dⱼ+dⱼ₊₁)/2.

The layer cross-sectional region generation unit 102 sets a value of a flag c indicating whether a layer cross-sectional region which is a cross-sectional region on the layer definition surface Fⱼ has been obtained for any of the manufacturing shapes M₁ to M₃ to a value “0” indicating that no cross-sectional region has been obtained (step S302).

The layer cross-sectional region generation unit 102 sets, by a manufacturing shape loop process repeatedly performed for each manufacturing shape, a manufacturing shape number i so as to increase by one for each repetition starting from 1 (step S303).

On the basis of layer definition surface data corresponding to the layer number j generated by the layer definition surface generation unit 101 and manufacturing shape data corresponding to the manufacturing shape number i input from the outside of the additive manufacturing path generation device 100, the layer cross-sectional region generation unit 102 generates a layer cross-sectional region R_{i,j} which is a cross-sectional region defined by a layer definition surface in a target manufactured object (step S304).

FIG. 7 is a diagram illustrating an example of a layer cross-sectional region generated by the additive manufacturing path generation device 100 illustrated in FIG. 1. FIG. 7 illustrates a layer cross-sectional region R_{0,j} which is a cross-sectional region defined by the layer definition surface Fⱼ in a manufacturing shape M₀. The layer cross-sectional region R_{0,j} is a region where the layer definition surface Fⱼ offset the distance di from the surface F in the perpendicular direction intersects the manufacturing shape M₀.

The layer cross-sectional region generation unit 102 checks whether there is the layer cross-sectional region R_{i,j} (step S305). If the layer cross-sectional region R_{i,j} is obtained (step S305: Yes), the layer cross-sectional region generation unit 102 sets the value of the flag c indicating whether a layer cross-sectional region is obtained in a manufacturing shape as a target to a value “1” indicating that the layer cross-sectional region is obtained (step S306).

On the basis of the layer definition surface data corresponding to the layer number j generated by the layer definition surface generation unit 101 and data on a reference path surface Gᵢ corresponding to the manufacturing shape Mᵢ input from the outside of the additive manufacturing path generation device 100, the reference path generation unit 103 generates a reference path TB_{i,j} by calculating an intersection line between the layer definition surface and the reference path surface (step S307).

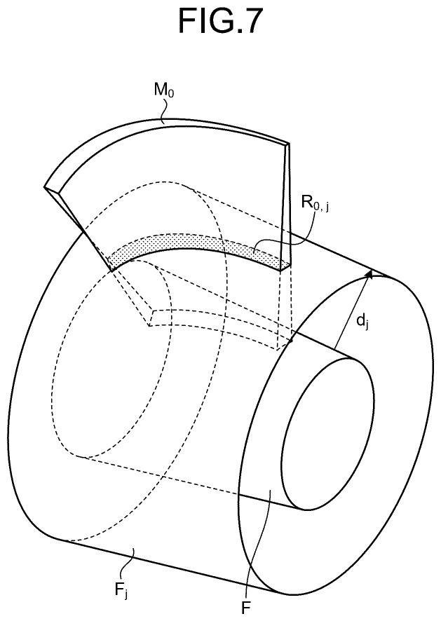

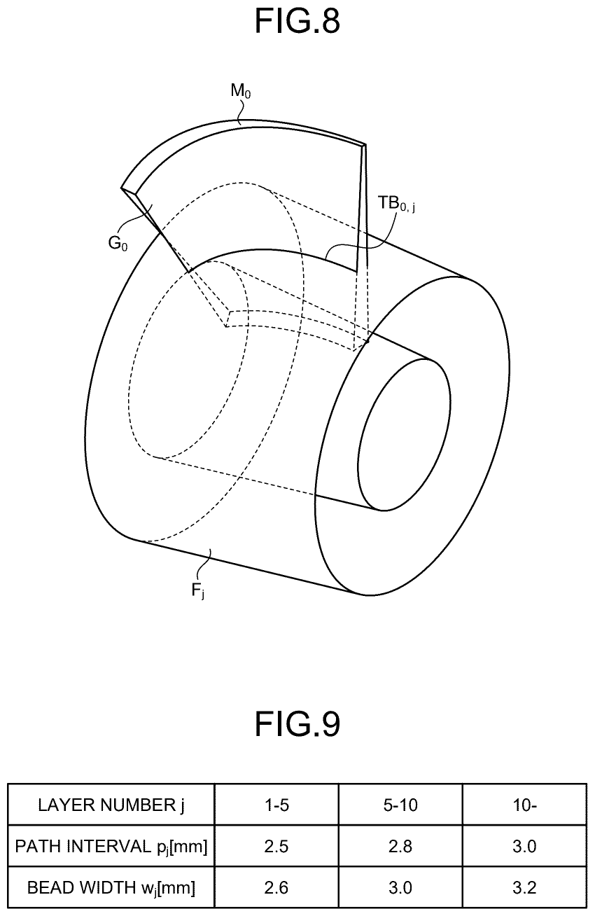

FIG. 8 is a diagram illustrating a reference path TB_{0,j} generated in the example illustrated in FIG. 7. FIG. 8 illustrates the reference path TB_{0,j} generated on the basis of the layer definition surface Fⱼ illustrated in FIG. 7 and a reference path surface G₀ corresponding to the manufacturing shape M₀.

The manufacturing path generation unit 104 generates a manufacturing path on the basis of the layer definition surface Fⱼ generated by the layer definition surface generation unit 101, the layer cross-sectional region R_{i,j} generated by the layer cross-sectional region generation unit 102, the reference path TB_{i,j} generated by the reference path generation unit 103, and the path definition data input from the outside of the additive manufacturing path generation device 100 (step S308).

FIG. 9 is a diagram illustrating an example of the path definition data. Here, the path definition data is data in which the layer number j for identifying each layer, an interval pⱼ between adjacent paths in each layer, and a bead width wⱼ which is a manufactured object for each path are associated with one another.

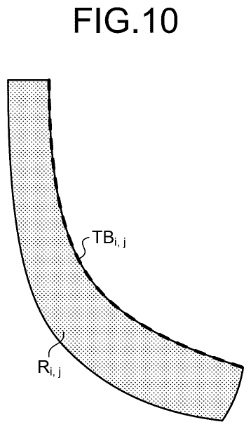

The generation of the manufacturing path in step S308 will now be described in detail. FIG. 10 is a diagram illustrating examples of the layer cross-sectional region R_{i,j} and the reference path TB_{i,j}. FIG. 10 illustrates one example of the layer cross-sectional region R_{i,j} generated in step S304 in FIG. 3. In addition, FIG. 10 illustrates one example of the reference path TB_{i,j} generated in step S307 in FIG. 3.

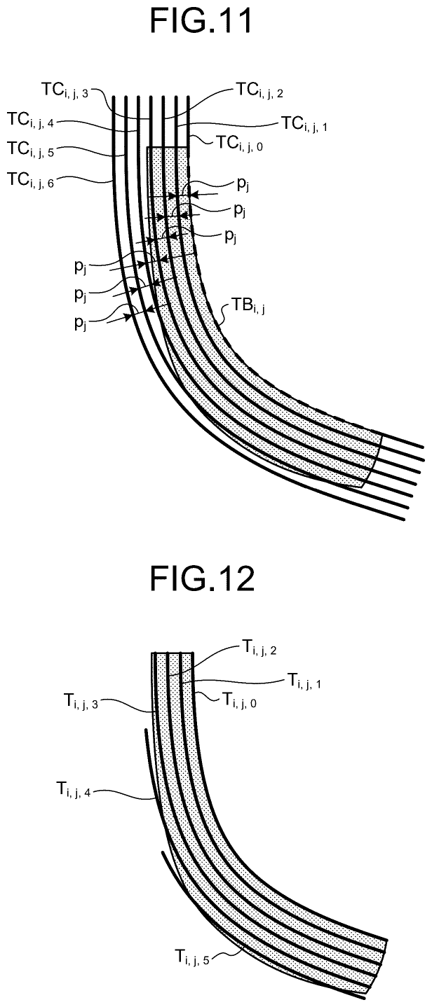

FIG. 11 is a diagram illustrating examples of manufacturing path candidates generated for the layer cross-sectional region illustrated in FIG. 10. First, the manufacturing path generation unit 104 generates a first path TC_{i,j,0} on the layer definition surface Fⱼ including the reference path TB_{i,j}. Furthermore, the manufacturing path generation unit 104 generates a path TC_{i,j,1} parallel to the first path TC_{i,j,0} while leaving the interval p; between paths with the generated first path TC_{i,j,0} as reference. Furthermore, the manufacturing path generation unit 104 generates a manufacturing path candidate TC_{i,j,k} by repeating a process of generating the next path while leaving the interval pⱼ between paths with the generated path as reference. k is an integer of 0 or more.

Subsequently, the manufacturing path generation unit 104 extracts a portion of each generated manufacturing path candidate TC_{i,j,k}, as a manufacturing path, the portion including a path having a center of a width, i.e., the bead width wⱼ of a region overlapping the layer cross-sectional region R_{i,j}. FIG. 12 is a diagram illustrating manufacturing paths generated from the manufacturing path candidates illustrated in FIG. 11. FIG. 12 illustrates manufacturing paths T_{i,j,0} to T_{i,j,5} extracted from manufacturing path candidates TC_{i,j,0} to TC_{i,j,5}. Since continuous manufacturing can be performed for a long with manufacturing paths based on the reference path, efficient manufacturing can be performed. FIG. 13 is an explanatory diagram regarding a procedure of generating a manufacturing path from a manufacturing path candidate. As illustrated in FIG. 13, the manufacturing path generation unit 104 defines, as a manufacturing path T_{i,j,k}, a portion of the manufacturing path candidate TC_{i,j,k} where a region having a width, i.e., the bead width w; centering the manufacturing path candidate TC_{i,j,k} intersects the layer cross-sectional region R_{i,j}.

For one manufacturing shape, the reference path generation unit 103 generates a reference path for each of the plurality of layers, on the basis of the single common reference path surface, and the manufacturing path generation unit 104 generates a manufacturing path on the basis of this reference path. Therefore, even in a case where layer cross-sectional shapes vary for each layer, a positional relationship between the layer cross-sectional region and the reference path can be maintained by designating an appropriate reference path surface, and thus a manufacturing path with which continuous manufacturing can be performed for a long time is obtained in each layer, which enables efficient manufacturing to be performed as a whole. Furthermore, positional deviation of the manufacturing path is reduced in upper and lower correlation, and thus a manufacturing defect such as sagging due to the positional deviation can be reduced.

In addition, by setting the interval pⱼ between adjacent manufacturing paths to be equal to or less than the bead width wⱼ, the layer cross-sectional region can be encompassed by a bead region which is a region where a bead is formed, and therefore, in a case where a near-net shape is manufactured by additive manufacturing and then finishing is performed by removal processing such as cutting, it is possible to manufacture a near-net shape that avoids a region shortage problem.

Furthermore, the interval pⱼ between adjacent manufacturing paths can be designated for each of the layer numbers. Consequently, in a case of manufacturing a shape in which more heat is stored in upper layers, the heat storage can be alleviated by performing the designation so as to provide wider intervals between adjacent manufacturing paths in upper layers, and thus stable manufacturing can be maintained.

Returning to the description of FIG. 3. When the manufacturing path is generated, the beam direction setting unit 105 sets a beam direction for the manufacturing shape data on the basis of the layer definition surface data generated by the layer definition surface generation unit 101, the manufacturing path data generated by the manufacturing path generation unit 104, and the reference path surface data, the manufacturing shape data, and the beam direction definition data input from the outside of the additive manufacturing path generation device 100 (step S309).

Here, the beam direction definition data is data indicating beam direction generation conditions. The beam direction definition data includes: data designating a method for calculating the initial beam direction; data on a minimum distance from a point on a manufacturing path to a manufacturing shape and data on a maximum angular difference between the initial beam direction and a perpendicular direction of a surface of the manufacturing shape facing the outside of the manufacturing shape, which indicate conditions of a portion to be extracted as an overhang portion of the manufacturing path; and data on a section distance in which in a portion which is not an overhang portion of the manufacturing path, a beam direction is gradually changed from a beam direction of an adjacent overhang portion to the initial beam direction.

Here, a beam direction setting procedure will be described. First, the beam direction setting unit 105 calculates and sets an initial beam direction for each point on the manufacturing path of the manufacturing path data. As the method for calculating the initial beam direction, there is a first method in which a perpendicular direction of a layer definition surface is calculated for each of a plurality of points on a manufacturing path, and a direction parallel to the calculated perpendicular direction and facing a layering direction is set as the initial beam direction. As the method for calculating the initial beam direction other than the first method, there is a second method in which a tangential direction of the manufacturing path and a perpendicular direction of a reference path surface are calculated for each of the plurality of points on the manufacturing path, and a direction parallel to a direction perpendicular to both the calculated tangential direction and perpendicular direction and facing the layering direction is set as the initial beam direction. According to the first method, the initial beam direction is a direction perpendicular to the layer definition surface, and according to the second method, the initial beam direction is a direction parallel to the reference path surface. The beam direction setting unit 105 can select and use any of the calculation methods on the basis of the data designating a method for calculating the initial beam direction included in the beam direction definition data.

Each of the beam direction obtained by the first method and the beam direction obtained by the second method has the following features. With the beam direction obtained by the first method, manufacturing can be performed under optimum conditions since the beam direction is a direction perpendicular to the cross section of the layer, but in a case where the layer cross section deviates as layering proceeds from lower to upper layers, an overhang portion is likely to occur under which the cross section of the lower layer does not exist with respect to the beam direction. With the beam direction obtained by the second method, manufacturing may not be performed under optimum conditions since the beam direction is not necessarily a direction perpendicular to the cross section of the layer, but even in the case where the layer cross section deviates as layering proceeds from lower to upper layers, the beam direction can be set so that the cross section of the lower layer is likely to be present depending on a way the reference path surface is taken, and it is possible to reduce occurrence of an overhang portion under which the cross section of the lower layer does not exist with respect to the beam direction.

As described above, since each of the first method and the second method has different features, when the initial beam direction can be selected for the layer definition surface, the manufacturing shape, the way the reference path surface is taken, and the like, stable manufacturing can be performed depending on a situation.

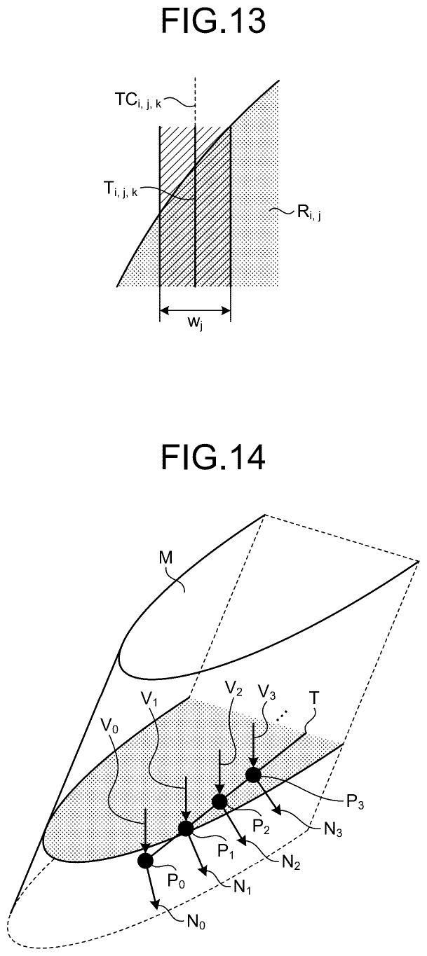

FIG. 14 is an explanatory diagram regarding setting of an initial beam direction. In FIG. 14, a manufacturing path T of a certain layer of a manufacturing shape M and points Pᵢ on the manufacturing path T are illustrated. In addition, initial beam directions Vᵢ generated by using the first method described above are also illustrated here.

The beam direction setting unit 105 sets the initial beam direction Vᵢ for each of the plurality of points Pᵢ on the manufacturing path T, and then extracts a point on the manufacturing path T of an overhang portion. Specifically, the beam direction setting unit 105 first extracts, among the points Pᵢ on the manufacturing path T, a point where a distance to a closest point on the surface of the manufacturing shape M is larger than the minimum distance included in the beam direction definition data. Here, the distance from any point Pᵢ on the manufacturing path T to the closest point on the surface of the manufacturing shape M is a distance obtained by adding a negative sign to the distance from the point Pᵢ on the manufacturing path T to the closest point of the surface of the manufacturing shape M if the point on the manufacturing path T is located inside the manufacturing shape, and adding a positive sign to the distance if the point on the manufacturing path T is located outside the manufacturing shape, and as the minimum distance included in the beam direction definition data, a negative value having a small absolute value is usually given.

This is due to the following reason: even a point on the manufacturing path located inside the manufacturing shape, if there is not a sufficient distance to penetration of the manufacturing shape at a time of advancement in a beam direction, there may occur a problem that the manufacturing shape collapses due to the influence of heat storage, and therefore a point on the manufacturing path located inside the manufacturing shape and close to the surface of the manufacturing shape is also extracted as a target of correction of the beam direction.

Next, among the extracted points on the manufacturing path, a point is extracted as a point of an overhang portion. The portion extracted as the point of the overhang portion is where an angle defined between the initial beam direction and a perpendicular direction facing the outside of the surface of the manufacturing shape at the closest point with respect to the surface of the manufacturing shape is smaller than the maximum angle difference included in the beam direction definition data. In the example illustrated in FIG. 14, points P₀, P₁, and P₂ are extracted as overhang portions.

Subsequently, the beam direction setting unit 105 corrects the beam direction at the points on the manufacturing path extracted as the overhang portions, such that the beam direction is changed from the initial beam direction to a direction parallel to the surface of the manufacturing shape.

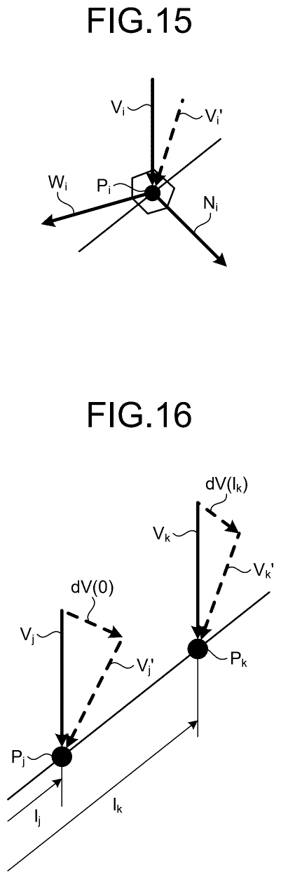

FIG. 15 is an explanatory diagram regarding a method for correcting a beam direction in an overhang portion. In FIG. 15, Pᵢ is a point on a manufacturing path extracted as an overhang portion, Vᵢ is an initial beam direction set for the point Pᵢ, Nᵢ is a perpendicular direction of a surface of a manufacturing shape facing the outside of the manufacturing shape at the closest point on the surface of the manufacturing path with respect to the point Pᵢ, and Vᵢ′ is a beam direction after correction. The beam direction setting unit 105 calculates a direction Wᵢ perpendicular to Vᵢ and Nᵢ, and calculates Vᵢ′ as a direction perpendicular to Nᵢ and Wᵢ. Vᵢ′ is a direction parallel to the surface of the manufacturing shape.

Wᵢ is expressed by the following formula (2), and Vᵢ′ which is the beam direction after correction is expressed by the following formula (3).

$$Formula 2$$

$${W}_{i} = \frac{{V}_{i} \times {N}_{i}}{\vert {V}_{i} \times {N}_{i} \vert} \qquad ( 2 )$$

$$Formula 3$$

$${V}_{i}^{′} = \frac{{N}_{i} \times {W}_{i}}{\vert {N}_{i} \times {W}_{i} \vert} \qquad ( 3 )$$

Subsequently, the beam direction setting unit 105 corrects the beam direction at a point of a non-overhang portion adjacent to the extracted overhang portion on the manufacturing path. At that time, using a section distance b within which the beam direction is corrected, the beam direction setting unit 105 corrects the beam direction for a point within the range of the section distance b from the boundary between the overhang portion and the non-overhang portion. The section distance b is information included in the beam direction definition data. Specifically, the beam direction setting unit 105 corrects the beam direction at the point within the range of the section distance b such that the beam direction is gradually changed from the beam direction for the overhang portion to the initial beam direction. A section in which the beam direction is gradually changed, that is, the range of the section distance b from the boundary between the overhang portion and the non-overhang portion is referred to as a gradual change section. By gradually changing the beam direction in the gradual change section, it is possible to prevent a sudden change in the beam direction with respect to a distance of movement on the manufacturing path. Therefore, in the additive manufacturing apparatus that performs additive manufacturing by using the manufacturing path in which the beam direction has been set, it is possible to avoid that a time-consuming operation of changing the beam direction leads to slow movement on the manufacturing path and excessive beam irradiation, and thus it is possible to perform stable manufacturing.

FIG. 16 is an explanatory diagram regarding correction of a beam direction in the gradual change section. In FIG. 16, Pⱼ is a point of an overhang portion adjacent to a non-overhang portion, and lⱼ is a distance from an end point on a manufacturing path to the point Pⱼ along the manufacturing path. Pₖ is a point where a distance from the point Pⱼ along the manufacturing path is within the section distance b, and a beam direction Vₖ′ after correction corresponding to the point Pₖ is expressed by the following formula (4).

$$Formula 4$$

$${V}_{k}^{′} = \frac{{V}_{k} + dv ( {l}_{k} )}{\vert {V}_{k} + dv ( {l}_{k} ) \vert} \qquad ( 4 )$$

Note that dv (lₖ) in the formula (4) can be calculated by using the following formulas (5) to (9).

$$Formula 5$$

$$dv ( l ) = \dot{h} ( l ) {\dot{V}}_{j} + \ddot{h} ( l ) b {\ddot{V}}_{j} \qquad ( 5 )$$

$$Formula 6$$

$${\dot{V}}_{j} = {V}_{j}^{′} - {V}_{j} \qquad ( 6 )$$

$$Formula 7$$

$${\ddot{V}}_{j} = \frac{{V}_{j}^{′} - {V}_{j - 1}^{′}}{{l}_{j} - {l}_{j - 1}} - \frac{{V}_{j + 1} - {V}_{j}}{{l}_{j + 1} - {l}_{j}} \qquad ( 7 )$$

$$Formula 8$$

$${\dot{h} ( l ) = {( 1 - t )}^{2} ( 1 + 2 t ) \vert}_{t = \frac{l - {l}_{i}}{b}} \qquad ( 8 )$$

$$Formula 9$$

$${\ddot{h} ( l ) = {( 1 - t )}^{2} t \vert}_{t = \frac{l - {l}_{i}}{b}} \qquad ( 9 )$$

By setting the beam direction calculated by the method as described above, it is possible to obtain a beam direction gradually changing smoothly along the manufacturing path from the beam direction of the overhang portion to the initial beam direction in the non-overhang portion on the manufacturing path.

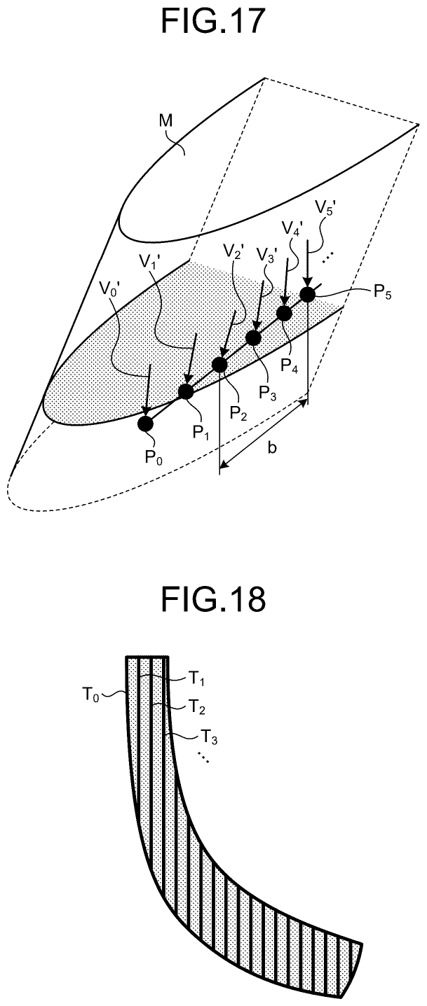

FIG. 17 is a diagram illustrating examples of beam directions after correction. FIG. 17 illustrates corrected beam directions V₀′, V₁′, and V₂′ for the points P₀, P₁, and P₂ on the manufacturing path extracted as the overhang portions. FIG. 17 also illustrates corrected beam directions V₃′, V₄′, and V₅′ for P₃, P₄, and P₅ which are points within the gradual change section in which a distance along the manufacturing path from the point P₂ of the overhang portion adjacent to the non-overhang portion is within the section distance b. The initial beam direction is set as it is except for the overhang portions and the points within the gradual change section.

In the manufacturing path in which the beam direction has been set by the beam direction setting unit 105 according to the present embodiment, while basically taking a beam direction suitable for the manufacturing of the layer, in a portion close to the surface of the manufacturing shape, the beam direction is corrected to the direction parallel to the surface of the manufacturing shape in the overhang portion in which the beam deviates from the layer cross-sectional region of the lower layer in the beam direction suitable for the manufacturing of the layer, and thereby the beam is prevented from deviating from the layer cross-sectional region of the lower layer. In addition, the gradual change section is set, and a beam direction is set which is gradually changed smoothly from the corrected beam direction of the overhang portion to the initial beam direction suitable for the manufacturing of the layer. Consequently, in a case of complex manufacturing in which there is an overhang portion in part, it is possible to, while preventing occurrence of a manufacturing defect such as partial sagging, prevent a situation in which a sudden change in the beam direction decreases the movement speed of a manufacturing position, which leads to excessive beam irradiation.

FIG. 18 is a diagram illustrating examples of manufacturing paths as targets of the beam direction setting unit 105 illustrated in FIG. 1. By application to various patterns of manufacturing paths such as manufacturing paths including a manufacturing path T₀ on the boundary of the layer cross-sectional region and a group of manufacturing paths T₁, T₂, T₃, . . . parallel to the reference path in the layer cross-sectional region, as illustrated in FIG. 18, the beam direction setting unit 105 can achieve a similar effect.

Returning to the description of FIG. 3. After setting the beam direction by the method described above, the beam direction setting unit 105 stores the manufacturing path in which the beam direction has been set in the manufacturing path storage unit 106 (step S310). Here, the manufacturing path data to be stored is data to which the manufacturing shape number related thereto, the layer number, and the adjacent number sequentially assigned in the adjacent direction from the manufacturing path on the reference path are added, and number data is used which has been added in order to specify manufacturing path data to be extracted when the manufacturing order determination unit 107 extracts manufacturing path data from the manufacturing path storage unit 106.

In order to switch the manufacturing shape to be processed to the next one to repeat the process, the layer cross-sectional region generation unit 102 returns the process to step S303 (step S311). In a case where the set manufacturing shape number exceeds the number of manufacturing shapes, the process exits a manufacturing shape loop of steps S303 to S311 and proceeds to step S312.

The layer cross-sectional region generation unit 102 checks the flag c indicating whether the layer cross-sectional region has been obtained for any of the manufacturing shapes, and determines whether a value of c is 0 (step S312). If the value of the flag c is 0 (step S312: Yes), that is, if the layer cross-sectional region cannot be obtained for any of the manufacturing shapes, the layer cross-sectional region generation unit 102 notifies the layer definition surface generation unit 101 that the generation of the manufacturing path is to be completed, and the layer definition surface generation unit 101 that has received the notification interrupts a loop process of switching the layer to be processed to the next one to repeat the process, and ends a manufacturing path generation process.

If the value of the flag c is not 0 (step S312: No), the layer definition surface generation unit 101 returns the process to step S300 in order to switch the layer to be processed to the next one to repeat the process (step S313).

The additive manufacturing path generation device 100 is realized by, for example, a computer system. The additive manufacturing path generation device 100 may be realized by one computer system or may be realized by a plurality of computer systems. For example, the additive manufacturing path generation device 100 may be realized by a cloud system. In the cloud system, it is possible to freely set distinction between hardware of the computer system and a device such as a server for each function. For example, one computer system may have a function as a plurality of devices, or a plurality of computer systems may have a function as one device.

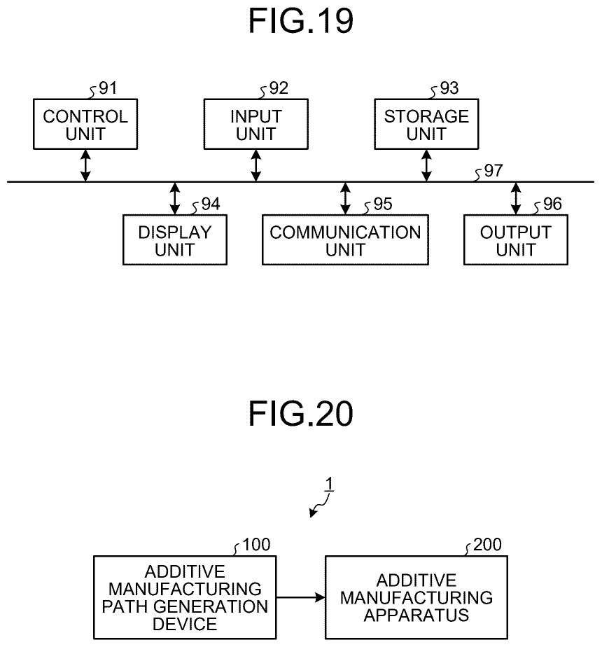

An exemplary configuration of a computer system that realizes the additive manufacturing path generation device 100 will be described. FIG. 19 is a diagram illustrating the exemplary configuration of the computer system that realizes the additive manufacturing path generation device 100 of the present embodiment. As illustrated in FIG. 19, the computer system includes a control unit 91, an input unit 92, a storage unit 93, a display unit 94, a communication unit 95, and an output unit 96, which are connected via a system bus 97.

In FIG. 19, the control unit 91 is a central processing unit (CPU), for example. The control unit 91 executes an additive manufacturing path generation program in which respective processes executed by the additive manufacturing path generation device 100 of the present embodiment are described. The input unit 92 includes, for example, a keyboard and a mouse, and is used by a user of the computer system in order to input various information. The storage unit 93 includes various memories such as a random access memory (RAM) and a read only memory (ROM), and a storage device such as a hard disk, and stores programs to be executed by the control unit 91, necessary data obtained during processes, and the like. The storage unit 93 is also used as a temporary storage area of a program. The display unit 94 includes a liquid crystal display (LCD) or the like, and displays various screens for the user of the computer system. The communication unit 95 is a communication circuit that performs a communication process, or the like. The communication unit 95 may include a plurality of communication circuits each corresponding to one of a plurality of communication methods. The output unit 96 is an output interface that outputs data to an external device such as a printer or an external storage device.

FIG. 19 is merely an example, and the configuration of the computer system is not limited to the example in FIG. 19. For example, the computer system may not include the output unit 96. In a case where the additive manufacturing path generation device 100 is realized by a plurality of computer systems, all of the computer systems may not be the computer system illustrated in FIG. 19. For example, some computer systems may not include at least one of the display unit 94, the output unit 96, and the input unit 92 illustrated in FIG. 19.

Here, a description will be given for an example operation of the computer system before it becomes possible to execute the additive manufacturing path generation program in which processes of the additive manufacturing path generation device 100 of the present embodiment are described. In the computer system having the above-described configuration, the additive manufacturing path generation program is installed in the storage unit 93 from a compact disc (CD)-ROM or a digital versatile disc (DVD)-ROM set in a CD-ROM drive or a DVD-ROM drive (not illustrated), for example. Then, when the additive manufacturing path generation program is executed, the additive manufacturing path generation program read from the storage unit 93 is stored in a region serving as a main storage device of the storage unit 93. In that state, the control unit 91 executes a process as the additive manufacturing path generation device 100 of the present embodiment in accordance with the additive manufacturing path generation program stored in the storage unit 93.

In the above description, the program in which processes by the additive manufacturing path generation device 100 are described is provided by using the CD-ROM or the DVD-ROM as a recording medium, but there is no limitation thereto. For example, a program provided by a transmission medium such as the Internet via the communication unit 95 may be used depending on the configuration of the computer system, the capacity of the program to be provided, and the like.

The additive manufacturing path generation program of the present embodiment causes a computer to execute: a step of generating, for each of a plurality of layers for manufacturing a manufactured object, a reference path from an intersection line between a layer definition surface and a reference path surface, the layer definition surface defining a target layer, the reference path surface being a surface that restrains a position of a reference path that is a reference for generating a manufacturing path; a step of generating, for each of the plurality of layers, a plurality of paths parallel to the reference path in the layer definition surface, the plurality of paths being manufacturing path candidates; and a step of generating a manufacturing path on the basis of the generated manufacturing path candidates, thereby generating a manufacturing path for manufacturing the manufactured object by layering a plurality of layers each formed by adding a material along the manufacturing path. At that time, in the step of generating the reference path, a plurality of reference paths each corresponding to one of the plurality of layers are generated on the basis of one reference path surface common to the plurality of layers.

The manufacturing path storage unit 106 illustrated in FIG. 1 is a part of the storage unit 93 illustrated in FIG. 19, and the layer definition surface generation unit 101, the layer cross-sectional region generation unit 102, the reference path generation unit 103, the manufacturing path generation unit 104, the beam direction setting unit 105, and the manufacturing order determination unit 107 illustrated in FIG. 1 are realized by the control unit 91 illustrated in FIG. 19. When the layer definition surface generation unit 101, the layer cross-sectional region generation unit 102, the reference path generation unit 103, the manufacturing path generation unit 104, the beam direction setting unit 105, and the manufacturing order determination unit 107 illustrated in FIG. 1 acquire data from the outside of the additive manufacturing path generation device 100, the data can be acquired via the input unit 92 or the communication unit 95 illustrated in FIG. 19. When the manufacturing order determination unit 107 outputs the generated manufacturing path to the outside of the additive manufacturing path generation device 100, the output can be performed via the communication unit 95 or the output unit 96 illustrated in FIG. 19. The manufacturing order determination unit 107 may output the generated manufacturing path by using the display unit 94.

Note that division of functions in respective devices illustrated in FIG. 1 is merely an example, and the division of functions in respective devices is not limited to the example illustrated in FIG. 1 as long as the above operations can be performed.

FIG. 20 is a diagram illustrating a configuration of an additive manufacturing system 1 including the additive manufacturing path generation device 100 illustrated in FIG. 1. According to the present embodiment, it is also possible to provide the additive manufacturing system 1 including the additive manufacturing path generation device 100 and the additive manufacturing apparatus 200 that performs an additive manufacturing process by using manufacturing paths generated by the additive manufacturing path generation device 100. The additive manufacturing apparatus 200 is an apparatus that generates an additive manufactured object by layering layers in which beads are laid which are manufactured objects generated by melting a material by beam irradiation, and as long as manufacturing is performed along a manufacturing path, any method may be used therefor.

The configurations described in the embodiment above are merely examples and can be combined with other known technology and part of the configurations can be omitted or modified without departing from the gist thereof.

### REFERENCE SIGNS LIST

1 additive manufacturing system; 91 control unit; 92 input unit; 93 storage unit; 94 display unit; 95 communication unit; 96 output unit; 97 system bus; 100 additive manufacturing path generation device; 101 layer definition surface generation unit; 102 layer cross-sectional region generation unit; 103 reference path generation unit; 104 manufacturing path generation unit; 105 beam direction setting unit; 106 manufacturing path storage unit; 107 manufacturing order determination unit; 200 additive manufacturing apparatus.

1. An additive manufacturing path generation device to generate a manufacturing path for manufacturing a manufactured object by layering a plurality of layers each formed by adding a material along the manufacturing path, the additive manufacturing path generation device comprising:
a processor to execute a program; and
a memory to store the program that when executed by the processor performs:
a reference path generation process of generating, for each of the plurality of layers for manufacturing the manufactured object, a reference path from an intersection line between a layer definition surface and a reference path surface, the layer definition surface defining a target layer, the reference path surface being a surface that restrains a position of the reference path that is a reference for generating the manufacturing path; and
a manufacturing path generation process of generating, for each of the plurality of layers, a plurality of paths parallel to the reference path in the layer definition surface, the plurality of paths being manufacturing path candidates, and generating the manufacturing path on a basis of the generated manufacturing path candidates, wherein
the reference path generation process comprises generating a plurality of the reference paths corresponding in one-to-one to the plurality of layers on a basis of the reference path surface, the reference path surface being single in number and common to the plurality of layers.

2. The additive manufacturing path generation device according to claim 1, wherein when executed by the processor, the program further performs:
a layer cross-sectional region generation process of generating, on a basis of the layer definition surface and a manufacturing shape of the manufactured object, a cross-sectional region defined by the layer definition surface in the manufactured object, wherein
the manufacturing path generation process comprises generating the manufacturing path by extracting, from the manufacturing path candidates, a portion where the cross-sectional region is to be manufactured.

3. The additive manufacturing path generation device according to claim 2, wherein in extracting, from the manufacturing path candidates, a portion where the cross-sectional region is to be manufactured, the manufacturing path generation process comprises extracting a portion of the manufacturing path candidate, as the manufacturing path, the manufacturing path candidate having a center of a predetermined width of a region overlapping the cross-sectional region.

4. The additive manufacturing path generation device according to claim 1, wherein by using an interval designated for each layer, the manufacturing path generation process generates a plurality of the manufacturing path candidates parallel to the reference path and spaced at the interval from one another.

5. The additive manufacturing path generation device according to claim 1, wherein when executed by the processor, the program further performs:
a beam direction setting process of setting set a beam direction that is an irradiation direction of a beam for melting the material when the layer is formed, wherein
the beam direction setting process comprises
setting an initial beam direction as the beam direction for the generated manufacturing path,
extracting an overhang portion that is a portion on a manufacturing path with the initial beam direction set, the overhang portion having an angle defined between the initial beam direction and a perpendicular direction facing an outside of a surface of a manufacturing shape of the manufactured object, the angle being less than or equal to a predetermined value, and
setting a beam direction for the overhang portion, the set beam direction for the overhang portion being parallel to the surface of the manufacturing shape, and sets a beam direction for a non-overhang portion that is adjacent to the overhang portion, the set beam direction for the non-overhang portion being gradually changed from the beam direction set for the overhang portion to the initial beam direction.

6. The additive manufacturing path generation device according to claim 5, wherein the beam direction setting process comprises setting a direction perpendicular to the layer definition surface, as the initial beam direction.

7. The additive manufacturing path generation device according to claim 5, wherein the beam direction setting process comprises setting a direction parallel to the reference path surface, as the initial beam direction.

8. An additive manufacturing path generation method for generating a manufacturing path for manufacturing a manufactured object by layering a plurality of layers each formed by adding a material along the manufacturing path, the additive manufacturing path generation method comprising:
generating, for each of the plurality of layers for manufacturing the manufactured object, a reference path from an intersection line between a layer definition surface and a reference path surface, the layer definition surface defining a target layer, the reference path surface being a surface that restrains a position of the reference path that is a reference for generating the manufacturing path;
generating, for each of the plurality of layers, a plurality of paths parallel to the reference path in the layer definition surface, the plurality of paths being manufacturing path candidates; and
generating the manufacturing path on a basis of the generated manufacturing path candidates, wherein
generating the reference path comprises generating, a plurality of the reference paths corresponding in one-to-one to the plurality of layers on a basis of the reference path surface, the reference path surface being single in number and common to the plurality of layers.

9. An additive manufacturing system comprising:
the additive manufacturing path generation device according to claim 1; and
an additive manufacturing apparatus to form the manufactured object by additive manufacturing in accordance with the manufacturing path generated by the additive manufacturing path generation device.

10. An additive manufacturing method for manufacturing a manufactured object by layering a plurality of layers each formed by adding a material along a manufacturing path, the additive manufacturing method comprising:
generating, for each of the plurality of layers for manufacturing the manufactured object, a reference path from an intersection line between a layer definition surface and a reference path surface, the layer definition surface defining a target layer, the reference path surface being a surface that restrains a position of the reference path that is a reference for generating the manufacturing path;
generating, for each of the plurality of layers, a plurality of paths parallel to the reference path in the layer definition surface, the plurality of paths being manufacturing path candidates;
generating the manufacturing path on a basis of the generated manufacturing path candidates; and
forming the manufactured object by additive manufacturing in accordance with the manufacturing path that has been generated, wherein
generating the reference path comprises generating a plurality of the reference paths corresponding in one-to-one to the plurality of layers are generated on a basis of the reference path surface, the reference path surface being single in number and common to the plurality of layers.
